(19) United States
(12) Patent Application Publication
(10) Pub. No.: US 2004/0223341 A1
(43) Pub. Date: Nov. 11, 2004

(54) High brightness light-emitting device

(76) Inventor: Bear Hsiung, Taipei (TW)

Correspondence Address: BROWDY AND NEIMARK, P.L.L.C., 624 NINTH STREET, NW, SUITE 300, WASHINGTON, DC, 20001-5303, US

(21) Appl. No.: 10/431,372

(22) Filed: May 8, 2003

(51) Int. Cl. F21V 7/04

(52) U.S. Cl. 362/555

(57) ABSTRACT

A high brightness light-emitting device is disclosed. The brightness light-emitting device comprises a mini battery; a circuit board installed on a surface of the mini battery; a light-emitting chip installed on the surface of the mini battery, wherein the light-emitting chip has a positive pole of electrically connected to positive pole of the mini battery, and a negative pole connected to a conductive wiring, which is electrically connected to the circuit board, and wherein the light-emitting chip and the conductive wiring are together encapsulated by transparent glue to avoid oxidation damage; and a contact switch having one end electrically connected to the circuit board and the other end electrically connected to negative pole of the mini battery.

### BACKGROUND OF THE INVENTION

1. Field of the Invention

The present invention relates to a high brightness light-emitting device. More particularly, the present invention relates to a light-emitting device including a high brightness chip installed and packaged on a miniature battery.

2. Description of the Prior Art

Decorative items incorporated with an eye-catching sparkling device are known in the art. FIG. 1 illustrates a prior art light-emitting device. The prior art light-emitting device, which is installed in a decorative item having a metal casing 5, comprises a mini battery 1, a conductive sheet 2, a light-emitting diode (LED) 3, and a vibration switch 4. The LED 3 has an anode pin 30 mounted to the conductive sheet 2. The conductive sheet 2 is electrically connected to the anode of the mini battery 1. The LED 3 has a cathode pin 31 soldered on the metal casing of the metal casing 5 of the decorative item, and the cathode pin 31 is electrically connected to the cathode of the mini battery 1 through the vibration switch 4.

The above-mentioned prior art light-emitting device has several drawbacks. First, the prior art light-emitting device has a LED 3 comprising an anode pin 30, which is soldered on the conductive sheet 2, and a cathode pin 31, which is soldered on the metal casing 5, such that the LED 3 is electrically connected with the mini battery 1. However, the soldering of the anode/cathode pins is difficult and the quality of the soldering process is hard to control, leading to high manufacturing cost and low production efficiency. Furthermore, the prior art light-emitting device occupies so much space that its applications are limited. Second, the LED 3 of the prior art light-emitting device has low brightness and is not opulent enough in some cases.

In light of foregoing, there is a need to provide an improved light-emitting device that occupies small space and has higher brightness.

### SUMMARY OF THE INVENTION

The main objective of the invention is to provide a high-brightness light-emitting device having small size. The manufacture process of the high-brightness light-emitting device according to this invention is simplified and improved quality.

To achieve these and other advantages and in accordance with the purposes of the present invention, as embodied and broadly described herein, the present invention provides a high brightness light-emitting device. The brightness light-emitting device comprises a mini battery; a circuit board installed on a surface of the mini battery; a light-emitting chip installed on the surface of the mini battery, wherein the light-emitting chip has a positive pole of electrically connected to positive pole of the mini battery, and a negative pole connected to a conductive wiring, which is electrically connected to the circuit board, and wherein the light-emitting chip and the conductive wiring are together encapsulated by transparent glue to avoid oxidation damage; and a contact switch having one end electrically connected to the circuit board and the other end electrically connected to negative pole of the mini battery.

The positive pole of the light-emitting chip 8 is directly mounted on the surface of the mini battery 6 and the negative pole of the light-emitting chip 8 is electrically connected to the circuit board 7 through the conductive wiring 81. Thereafter, the chip and the conductive wiring are packaged. The manufacture process is simplified and is easily automated for mass production. The resultant package structure is solid and the quality of the product is greatly improved.

Other objects, advantages and novel features of the invention will become more clearly and readily apparent from the following detailed description when taken in conjunction with the accompanying drawings.

### BRIEF DESCRIPTION OF THE DRAWINGS

FIG. 1 illustrates a prior art light-emitting device.

FIG. 2 is an exploded view of this invention.

FIG. 3 is a perspective view of this invention.

FIG. 4 is a side view of this invention.

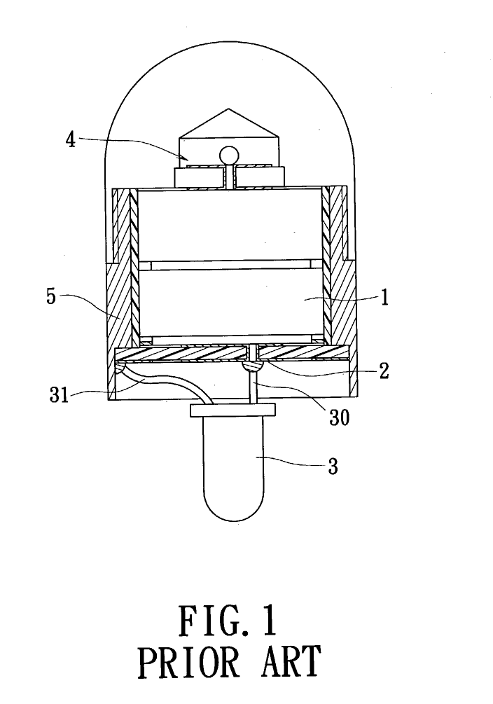

### DETAILED DESCRIPTION OF THE PREFERRED EMBODIMENT

It is understood that the accompanying drawings are included to provide a further understanding of the invention, and are incorporated in and constitute a part of this specification. The drawings illustrate embodiments of the invention and, together with the description, serve to explain the principles of the invention.

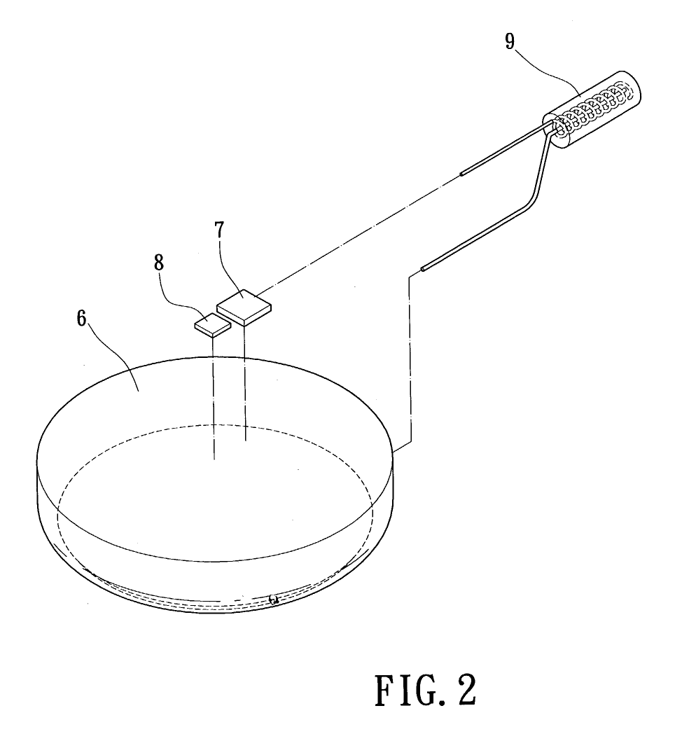

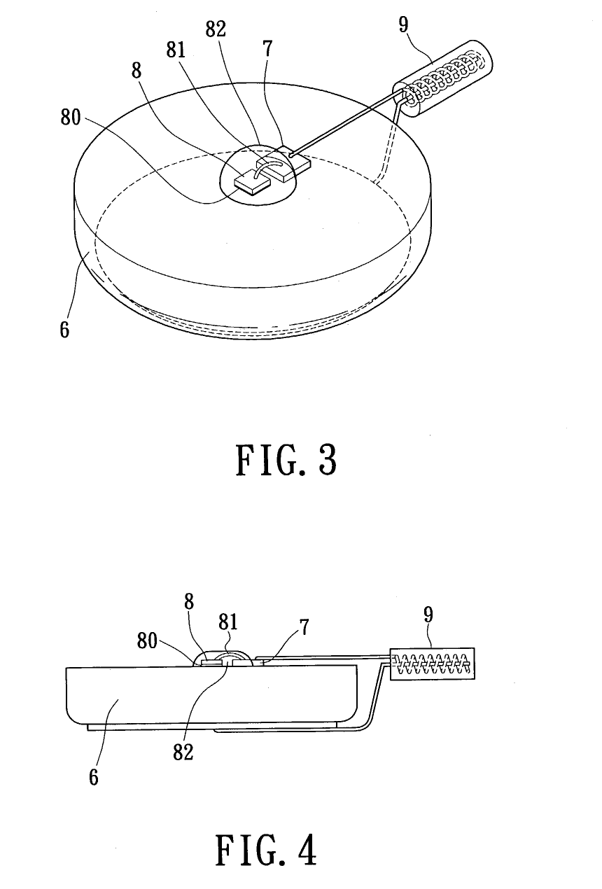

The present invention pertains to a high brightness light-emitting device. Please refer to FIG. 2 to FIG. 4. FIG. 2 is an exploded view of this invention. FIG. 3 is a perspective view of this invention. FIG. 4 is a side view of this invention. The high brightness light-emitting device of this invention comprises a min battery 6, a circuit board 7, a light-emitting chip 8, and a contact switch 9.

The mini battery 6 may be a silver oxide battery, an alkaline battery, or a lithium battery, but not limited thereto.

The circuit board 7 is mounted on the surface of the positive pole (cathode) of the mini battery 6.

The light-emitting chip 8 is mounted on the upper surface of the mini battery 6. The light-emitting chip 8 may be a LED chip. The positive pole (cathode) of the light-emitting chip 8 is adhered to the mini battery 8 with conductive glue 80, for example, silver glue, so that the positive pole of the light-emitting chip 8 is electrically connected to the positive pole of the mini battery 6. The negative pole (anode) of the light-emitting chip 8 is connected to a conductive wiring 81, which is electrically connected to the circuit board 7. As best seen in FIG. 3 and FIG. 4, to avoid oxidation damage, the light-emitting chip 8 and the conductive wiring 81 are together encapsulated by transparent glue 82.

The contact switch 9 may be a vibration switch having one end solder on the circuit board 7 so that the contact switch 9 is electrically connected to the circuit board 7. The other end of the contact switch 9 is soldered on the negative pole of the mini battery 6 so that the contact switch 9 is electrically connected to the negative pole of the mini battery 6.

The present invention light-emitting device has small size such that it can be installed in various items, such as backpacks, earrings, hair clips, buttons, or other hanging decorations. By way of example, when the light-emitting device is installed in an earring, which is wore by a user, intermittent conduction occurs between the positive/negative poles of the contact switch 9 when the earring swings. The light-emitting chip 8 sparkles and produces opulent effects.

The light-emitting chip 8 is high brightness chip giving the decorative items eye-catching light. It is worthy noted that the heat generated by the high brightness chip may be rapidly dissipated through the metal surface of the mini battery 6. It is advantageous that the heat dissipation through the metal surface of the mini battery 6 ensures the performance of the light-emitting chip 8 even after long-term usage without the fear of burning out the light-emitting chip 8. Moreover, the positive pole of the light-emitting chip 8 is directly mounted on the surface of the mini battery 6 and the negative pole of the light-emitting chip 8 is electrically connected to the circuit board 7 through the conductive wiring 81. After this, the chip and the conductive wiring are packaged. The manufacture process is simplified and is easily automated for mass production. The resultant package structure is solid and the quality of the product is greatly improved.

In summary, the present invention high brightness light-emitting device has the following features.

(1) The light-emitting chip is high brightness chip. When the high brightness light-emitting chip is installed in a decorative item, it brings opulent effects. Further, the size of the device is reduced, making it more flexible to be applied to some small decorative items.

(2) The light-emitting chip is mounted on the positive pole of the min battery. The heat generated by the chip is dissipated by the metal surface of the battery. This ensures the performance of the high brightness light-emitting chip and is space-saving.

(3) The positive pole of the light-emitting chip 8 is directly mounted on the surface of the mini battery 6 and the negative pole of the light-emitting chip 8 is electrically connected to the circuit board 7 through the conductive wiring 81. Thereafter, the chip and the conductive wiring are packaged. The manufacture process is simplified and is easily automated for mass production. The resultant package structure is solid and the quality of the product is greatly improved.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A high brightness light-emitting device, comprising:
a mini battery;
a circuit board installed on a surface of the mini battery;
a light-emitting chip installed on the surface of the mini battery, wherein the light-emitting chip has a positive pole of electrically connected to positive pole of the mini battery, and a negative pole connected to a conductive wiring, which is electrically connected to the circuit board, and wherein the light-emitting chip and the conductive wiring are together encapsulated by transparent glue to avoid oxidation damage; and
a contact switch having one end electrically connected to the circuit board and the other end electrically connected to negative pole of the mini battery.

2. The high brightness light-emitting device as claimed in claim 1 wherein the mini battery is a silver oxide battery.

3. The high brightness light-emitting device as claimed in claim 1 wherein the mini battery is an alkaline battery.

4. The high brightness light-emitting device as claimed in claim 1 wherein the mini battery is a lithium battery.

5. The high brightness light-emitting device as claimed in claim 1 wherein the circuit board is mounted on positive pole surface of the mini battery.

6. The high brightness light-emitting device as claimed in claim 1 wherein the contact switch is a vibration switch.

7. The high brightness light-emitting device as claimed in claim 1 wherein the positive pole of the light-emitting chip is adhered to the mini battery with conductive glue.

8. The high brightness light-emitting device as claimed in claim 7 wherein the conductive glue comprises silver glue.
